(19) United States
(12) Patent Application Publication
(10) Pub. No.: US 2006/0016826 A1
(43) Pub. Date: Jan. 26, 2006

(54) Coupling plate for stacking lottery ticket dispensers

(76) Inventor: Craig A. Jensen, Van Meter, IA (US)

Correspondence Address: G. Brian Pingel;Brown, Winick, Graves, Gross,, Baskerville and Schoenebaum, P.L.C., Regency West 5, 4500 Westown Parkway, Ste. 277, West Des Moines, IA, 50266, US

(21) Appl. No.: 10/895,527

(22) Filed: Jul. 21, 2004

(51) Int. Cl. G07F 11/00

(52) U.S. Cl. 221/199

(57) ABSTRACT

A coupling plate is provided to serve as a connecting member for stacking a fabricated ticket dispenser on top of a box-type molded dispenser in a semi-permanent relationship.

### BACKGROUND OF THE INVENTION

1. Field of the Invention

The present invention relates in general to a structure that assists in the stacking of molded and fabricated lottery ticket dispensers. More particularly, this invention relates to a coupling plate that serves as an intermediate member for demountably attaching a fabricated ticket dispenser to the top of a molded dispenser.

2. Description of the Prior Art

The use of stackable box-like structures for displaying and dispensing of lottery tickets has long been known in the art. Originally, the most common popular methods for attaching such structures in a stackable arrangement had been either permanent or not lockable. However, over a decade ago, a molded stackable display and dispensing structure was developed to include engagement means on the top of the structure that were adapted to co-act with engagement means on the bottom of a second similarly shaped structure for attachment in a stacked and locked arrangement. Such structure is disclosed in U.S. Pat. No. 5,399,005 issued to Schafer on Mar. 21, 1995.

The stacking and locking features of the Schafer invention have proven to be highly popular and successful in utilization with molded ticket dispensing structures that include the necessary engagement means molded therein, but such invention is not normally applicable with dispensers that are fabricated by hand to accommodate unusually sized lottery tickets. Although the vast majority of lottery tickets utilized in the lottery industry have standard dimensions so they can be dispensed from a wide variety of different ticket dispensers, occasionally a particular state lottery will conduct a promotion that utilizes a ticket of an unusual size. To accommodate such tickets, dispenser manufacturers have the capability for manufacturing fabricated dispensers by hand. Because fabricated dispensers do not include molded engagement means therein, they are not designed to be conveniently arranged in an interchangeable stacked relationship. Instead, such dispensers are normally attached by double-sided adhesive to the countertop of a retail establishment or to the top of a molded dispenser in such fashion that they cannot be readily removed therefrom.

The present invention provides a coupling plate that serves as an intermediate coupling member between a fabricated dispenser and a molded dispenser in such fashion that the two can be readily removed from one another.

### SUMMARY OF THE INVENTION

The present invention is a coupling plate that is adapted to serve as a connecting member for stacking a fabricated ticket dispenser on top of a box-type molded dispenser in a semi-permanent arrangement, and includes engagement means for co-acting with the engagement means on the molded dispenser. The coupling plate is formed with a plate-type body portion having generally flat top and bottom surfaces, a first engagement means extended downwardly from the front of the body portion and a second engagement means extending downwardly from the rear of the body portion. The first engagement means is designed to co-act with a lip portion on the top of the molded dispenser for attachment thereto and the second engagement means extends through notches in the roof of the molded dispenser and is overlapped by a flange on the door of such dispenser to lockably secure the coupling plate to the dispenser.

The foregoing and other advantages of the present invention will appear from the following description. In the description, reference is made to the accompanying drawings, which form a part hereof, and in which there is shown by illustration and not of limitation a specific form in which the invention may be embodied. Such embodiment does not represent the full scope of the invention, but rather the invention may be employed in a variety of other embodiments and reference is made to the claims herein for interpreting the breadth of the invention.

### BRIEF DESCRIPTION OF THE DRAWINGS

FIG. 1 is a rear perspective view of a prior art molded lottery ticket dispenser;

FIG. 2 is a side cross sectional view of the dispenser unit of FIG. 1 in a partially engaged assembly relationship with an identically formed top dispenser;

FIG. 3 is a view similar to that of FIG. 2 but with the top dispenser fully engaged with the bottom dispenser in a stacked and locked condition;

FIG. 4 is a rear perspective view of a prior art fabricated ticket dispenser;

FIG. 5 is a rear perspective view of a preferred embodiment of a coupling plate of the present invention that is adapted to assist in demountable connecting the fabricated dispenser of FIG. 4 on top of the molded dispenser of FIG. 1;

FIG. 6 is a side view in elevation of the coupling plate of FIG. 5;

FIG. 7 is a rear perspective view of the coupling plate of FIG. 5 mounted on the top of the molded dispenser of FIG. 1;

FIG. 8 is a rear perspective view similar to that of FIG. 7 but with the fabricated dispenser of FIG. 4 mounted on top of the coupling plate of FIG. 5; and

FIG. 9 is a cross sectional view taken along the line 9-9 in FIG. 8.

### DETAILED DESCRIPTION OF THE PREFERRED EMBODIMENT

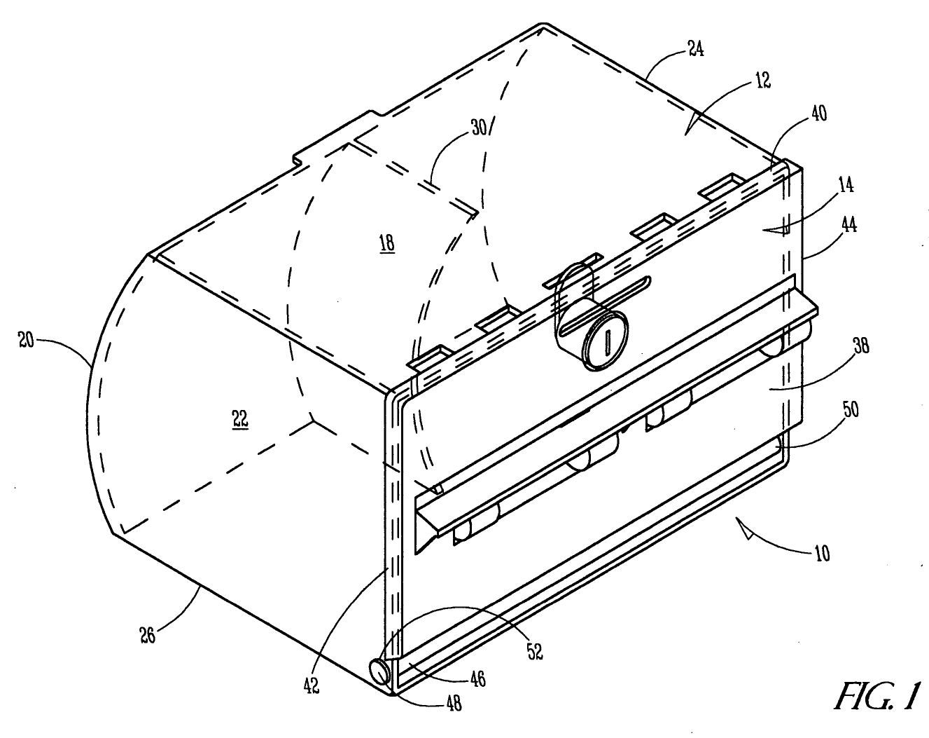

With reference now to the drawings, a dual modular hinged lottery ticket dispenser known in the prior art is shown in FIG. 1 indicated generally at 10 and includes a box unit 12 and a door 14.

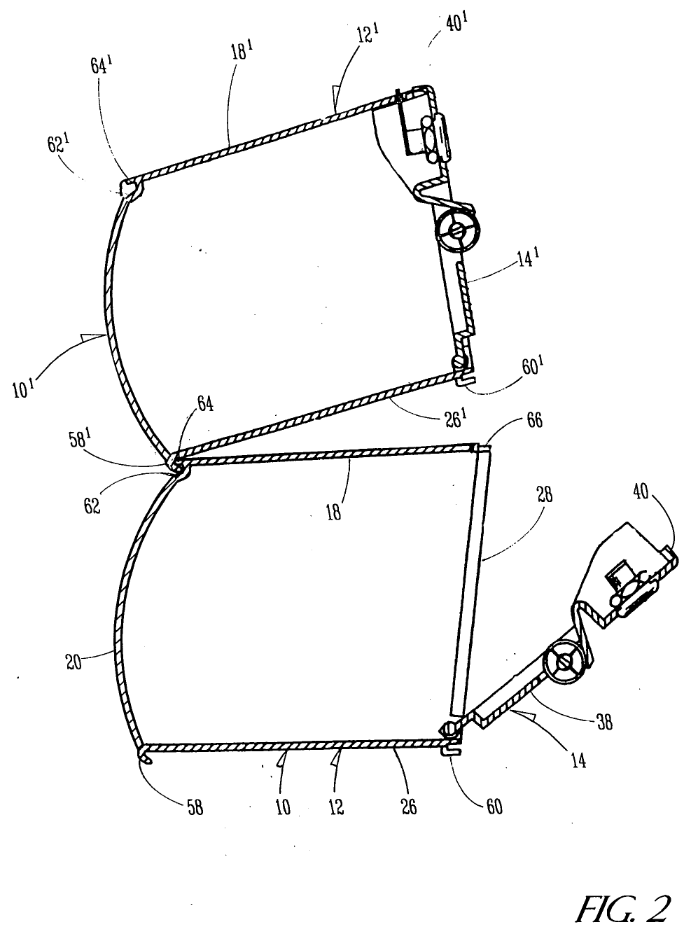

The box unit 12 has a top surface 18, a front wall 20, a pair of opposite side walls 22 and 24, a bottom surface 26 and a rear opening 28 (see FIG. 2) that allows access to the inside of the unit 12. Located within the unit 12 is a divider portion 30 for forming two storage compartments, which are adapted for storing two stacks of lottery tickets in a side-by-side relationship.

The door 14 has a vertical face 38, a horizontal top flange 40 and a pair of vertical side flanges 42 and 44. A bottom portion 46 of the door 14 is generally cylindrical in shape and has a pair of cylindrical posts 48 and 50 at opposite ends. The posts 48 and 50 are designed to be receivably journaled in circular openings 52 in the sidewalls 22 and 24 to pivotally attach the bottom portion 46 of the door 14 to the box unit 12. The dispenser 10 is preferably entirely molded of a clear plastic material such as polycarbonate. Such material has inherent flexible and resilient qualities. Because of such flexible and resilient qualities, the door 14 is semi-permanently attachable to the box unit 12.

Referring now to FIG. 2, the top 18 of the box unit 12 and the bottom 26 thereof are formed with co-acting engagement means for stacking a plurality of dispensers, one on top of another, in a stacked and locked relationship. The engagement means located on the bottom 26 include a curved flange 58 that extends downwardly from the bottom 26 at the front of the box unit 12 and four spaced apart downwardly extending L-shaped flanges 60, only one of which can be seen, located at the rear of the box unit 12. The engagement means at the top portion of the box unit 12 include at its front a recessed pocket 62 that lies directly beneath a lip portion 64 formed by the front edge of the box unit top 18. On the opposite side of the top 18 are rear engagement means in the form of a plurality of spaced apart notches 66 in the rear edge of the top 18.

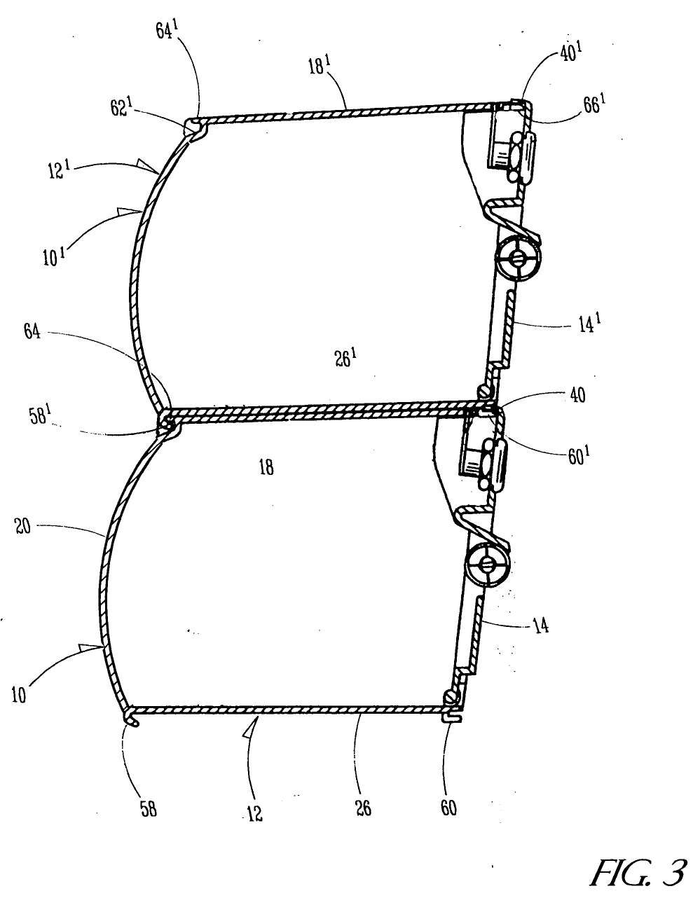

Referring now to both FIGS. 2 and 3, the dispenser 10 and a similarly constructed dispenser 10′ are shown in an assembly relationship. Because the construction of the dispensers 10 and 10′ are identical, similar components of each will be numbered the same except that the components of the dispenser 10′ are primed.

The dispenser 10′ includes a bottom 26′ that co-acts with the engagement means on the top 18 of the dispenser 10, with a front flange 58′ hooking over the lip 64 to secure the front portions of the dispensers 10 and 10′ together. Simarily, the dispenser 10′ has rear flanges 60′ that extend through the notches 66 in the dispenser 10. Thus, when the door 14 is closed the top door flange 40 overlies the flanges 60′ to secure the dispenser 10′ in place in a semi-permanent relationship with the dispenser 10, all as described in U.S. Pat. No. 5,399,005 issued Mar. 21, 1995, and incorporated herein by reference.

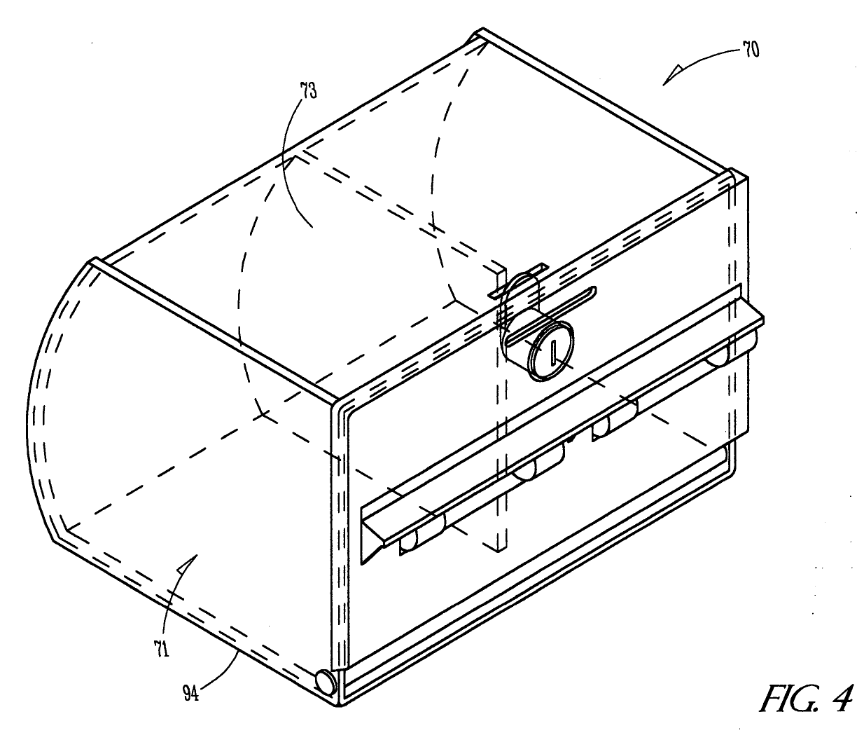

The above-described co-action between the engagement means of the molded dispensers 10 and 10′ works effectively to lockably secure such dispensers together. However, such securement is unavailable for prior art hand made fabricated dispensers 70, as illustrated in FIG. 4 which do not have the engagement means of the molded units 10 and 10′.

The dispenser 70 has a box unit 71 with a divider 73 to form dual storage compartments similar to that of the molded dispensers 10 and 10′. The dispenser 70 is adapted for dispensing unusually sized tickets that cannot be accommodated in the dispensers 10 and 10′. However, because the dispenser 70 does not have engagement means, normally the dispenser 70 must be fastened to the top of a retail establishment's sales counter or attached to the top of a molded unit 10 through the use of double-sided adhesive tape. Accordingly, the dispenser 70 cannot be readily switched in position with other types of dispensers as conveniently as can be done with the molded dispensers 10 and 10′. The present invention has been adapted for the sole purpose of essentially providing engagement means on the bottom of the fabricated dispenser 70 in a somewhat similar fashion to the engagement means of the molded dispenser 10 so that the two can be interchangeably connected together.

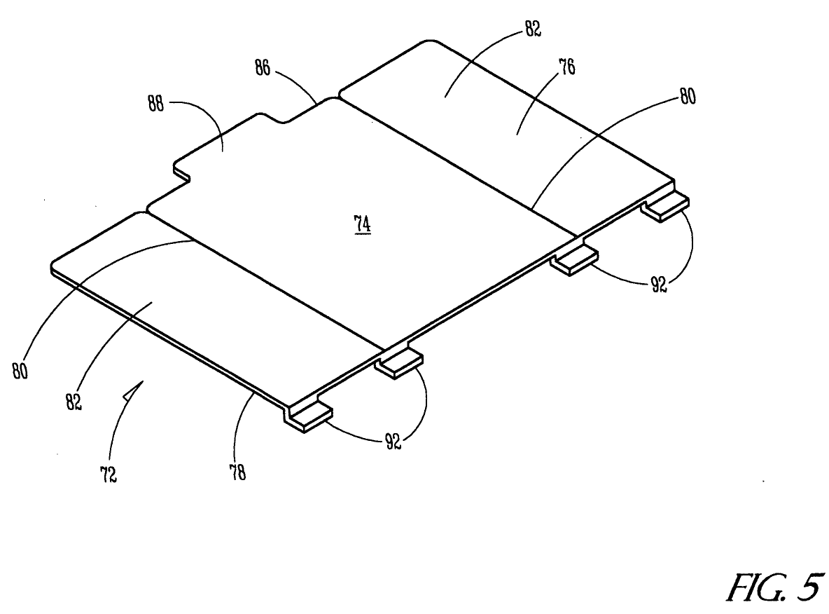

Referring now to FIG. 5, a preferred embodiment of the coupling plate of the present invention is shown generally at 72 and is formed of a relatively thin plate-type body portion 74 having generally flat top and bottom surfaces 76 and 78 respectively. The plate 72 has a width that is sized for use with the fabricated dispenser 70 that has dual ticket storage compartments. However, the plate 72 includes two spaced-apart transverse score lines 80 that allow outer ends 82 of the body portion 74 to be broken off if it is desired to utilize the plate 72 in association with a single ticket storage compartment dispenser.

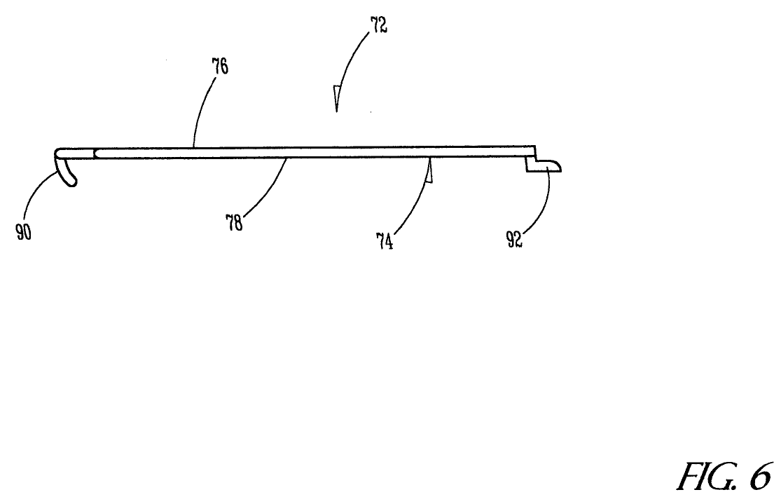

Referring now to both FIGS. 5 and 6, the coupling plate 72 includes engagement means that are similar in construction to the engagement means of the dispensers 10 and 10′. As indicated, the front edge 86 of the plate 72 is formed with an outwardly extending central ledge portion 88 that terminates in a downwardly directed arcuate flange 90 (see FIG. 6) that is similar in shape to the front flange 58 on the dispenser 10.

The flange 90 is adapted to engage the lip 64 and extend into the front pocket 62 of the dispenser 10 in similar fashion to the flange 58 for securing the front portion of the plate 72 to the front portion of the dispenser 10. Similarly, the plate 72 includes rear engagement means in the form of four L-shaped flanges 92 that resemble the bottom rear flanges 60 of the dispenser 10.

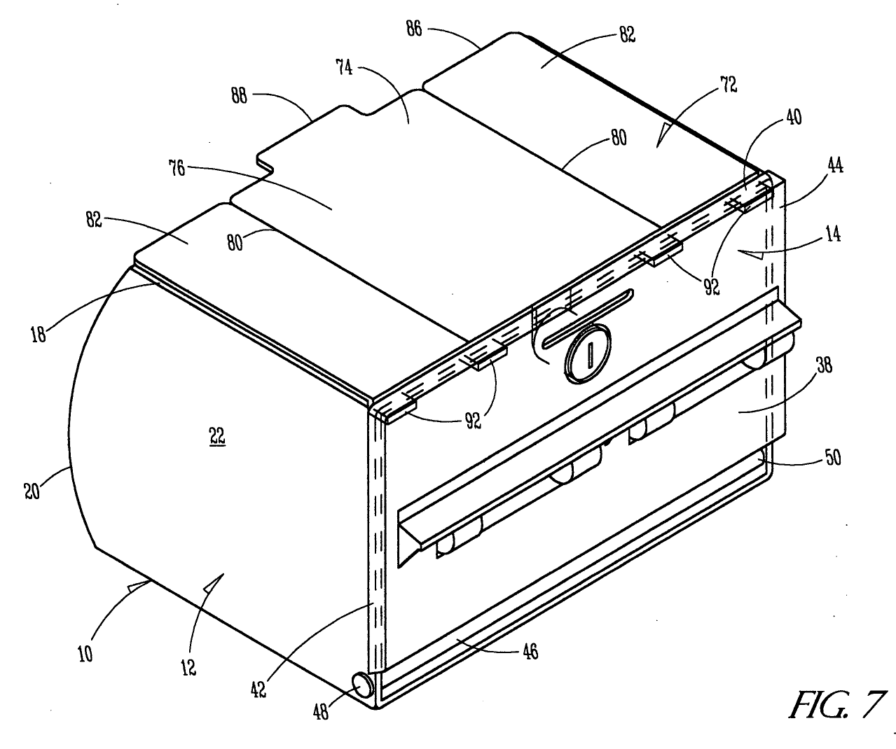

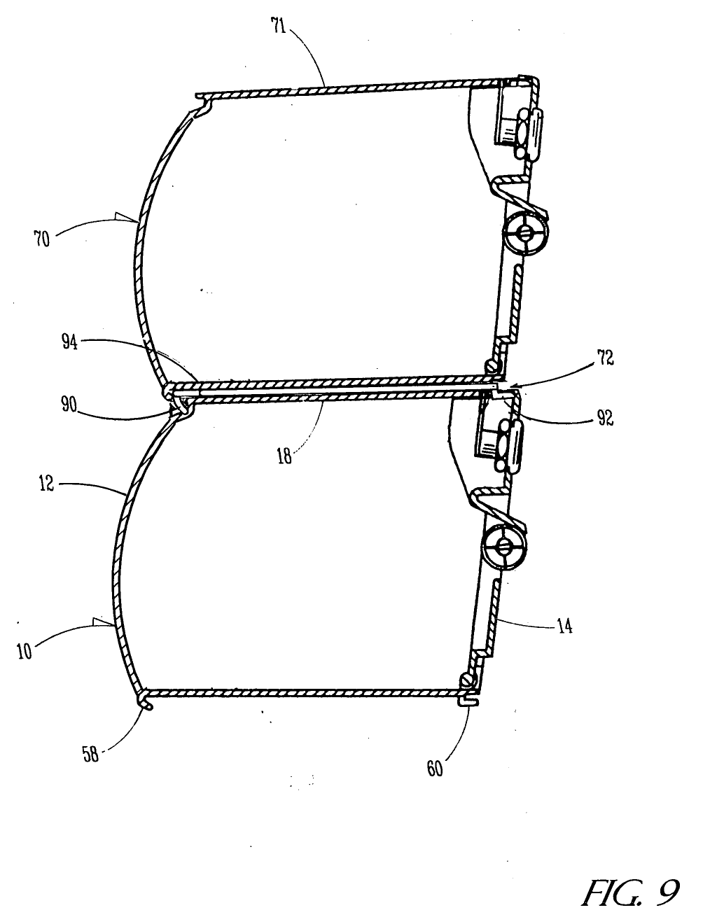

The flanges 92 are designed for being positioned into the notches 66 of the dispenser 10 for engagement with the top door flange 40, which secures the rear portion of the coupling plate 72 to the top of the dispenser 10 as indicated best in FIG. 9. Thus, the coupling plate 72 is designed for co-acting with the engagement means on the top of the molded dispenser 10 in the same manner as if it were the bottom portion of the molded dispenser 10′ and, consequently, can be readily attached with (see FIG. 7) or removed from the dispenser 10 as desired.

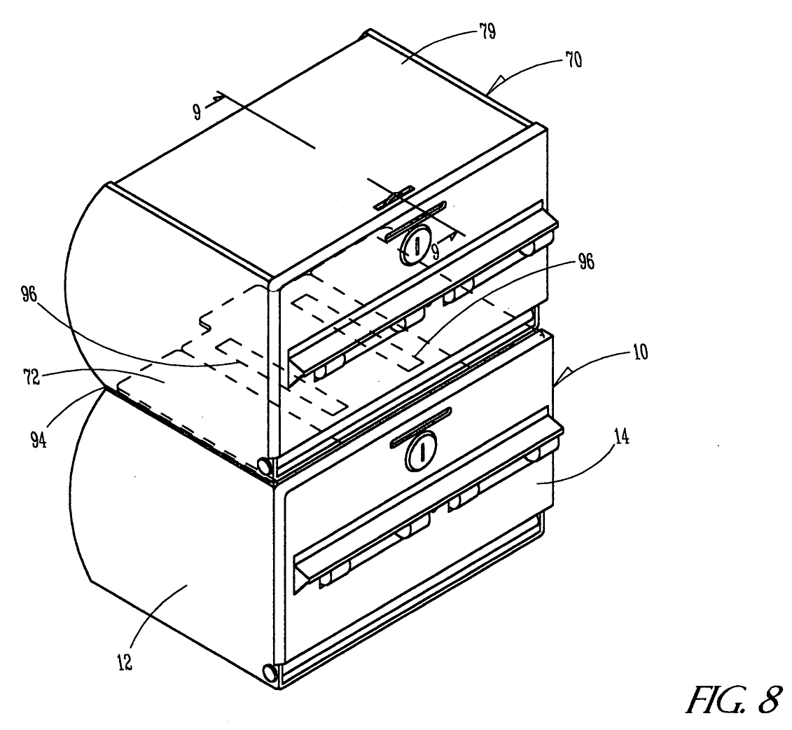

To assemble the fabricated dispenser 70 in a stackable relationship with the molded dispenser 10, as shown in FIGS. 8 and 9, simply requires the attachment of the coupling plate 72 to a bottom 94 of the dispenser 70 by attachment means, preferably of strips 96 of two-sided adhesive tape, which semi-permanently connect the plate 72 to the dispenser 70. Once such connection is made, the assembly formed of the fabricated dispenser 70 and the coupling plate 72 is ready for assembly with the dispenser 10.

It can, thus, be readily seen that the present invention provides a simple and efficient means for serving as a releasable but locked connecting means between a fabricated ticket dispenser and a molded ticket dispenser. Although the invention has been described with respect to a preferred embodiment thereof, it is to be understood that the invention is not to be so limited since changes and modifications can be made therein which are within the full-intended scope of this invention as defined by the appended claims.

What is claimed is:

1. A coupling plate that is adapted for serving as a connecting member for stacking a fabricated lottery ticket dispenser on top of a molded lottery ticket dispenser having a rear door, said coupling plate comprising:
(a) a thin plate-type body portion having generally flattop and bottom surfaces;
(b) first engagement means extending downwardly from the front of said body portion for engaging said molded dispenser;
(c) second engagement means extending downwardly from the rear of said body portion for engaging said molded dispenser; and
(d) said second engagement means is adapted to co-act with said door on said molded dispenser to demountably lock said plate to the top of said molded dispenser.

2. The coupling plate as described in claim 1, wherein:
(a) said molded dispenser includes:
(1) a front wall with an upper portion having a cavity to provide a frontwardly extending lip portion;
(2) said door is pivotally attached at a lower portion of the rear end of said dispenser and is semi-permanently attached at an upper portion thereof to serve as a rear wall of said dispenser when in a closed condition, said door having an upper end with a frontwardly extending flange; and
(3) a roof having a rear edge with at least one notch;
(b) said first engagement means of said plate coacts with said lip portion to secure the front of said body portion of said plate to the front of said molded dispenser; and
(c) said second engagement means extends through said notch in the roof of said molded dispenser and is overlapped by the flange on said door to secure the rear of said body portion of said plate to the rear of said molded dispenser.

3. The coupling plate as described in claim 2, wherein:
(a) said first engagement means is in the form of an arcuate flange that hooks over said lip portion; and
(b) said second engagement means is generally in the form of an “L” shape.

4. The coupling plate as described in claim 3, wherein the rear edge of said molded dispenser roof has a plurality of said notches and said plate has an equal number of said second engagement means.

5. The coupling plate as described in claim 3, wherein said molded-dispenser has side-by-side storage compartments for lottery tickets and said coupling plate overlies at least ninety percent of the roof of said molded dispenser.

6. The coupling plate as described in claim 5, wherein the body portion of said plate has a pair of transverse score lines that extend from the front of said body portion to the rear thereof on opposite sides of said first and second engagement means.

7. A stackable locking display and dispensing structure comprising:
(a) a base unit of box-like configuration having a floor, a roof, a pair of sidewalls and an open rear-end, said roof having a rear edge with at least one opening;
(b) a base unit door pivotally attached at the lower portion of the rear end of said base unit and semi-permanently attachable at an opposite upper portion of the rear end of said base unit to serve as a rear wall for said base unit when in a closed position;
(c) a top unit of box-like configuration generally similar in shape and size to said base unit;
(d) a coupling plate to assist in demountably attaching said top unit in association with the base unit in a stackable arrangement, said plate including:
(1) a plate-type body portion having generally flattop and bottom surfaces;
(2) first engagement means extending downwardly from the front of said body portion for engaging said base dispenser;
(3) a second engagement means extending downwardly from the rear of said body portion for engaging said base dispenser; and
(4) said second engagement means is adapted to co-act with said door on said base dispenser to demountably lock said plate to the top of said base dispenser; and
(e) adhesive means for attaching said coupling plate to the bottom of said top unit.

8. The dispensing structure as described in claim 7, wherein said coupling plate further includes a pair of transversely arranged score lines that extend from the front of said body portion to the rear thereof.

9. The dispensing structure as described in claim 7, wherein said based dispenser includes a front wall with an upper portion having a cavity to provide a frontwardly extending lip portion and said first engagement means is in the form of an arcuate flange that hooks over said lip portion.

10. The stackable locking display and dispensing structure as described in claim 7, wherein said second engagement means is generally in the form of an “L” shape that extends downwardly through said opening of said base unit roof and coacts with said door to secure said plate to said base unit.
